(19) United States
(12) Patent Application Publication
(10) Pub. No.: US 2019/0349609 A1
(43) Pub. Date: Nov. 14, 2019

(54) SYSTEM AND METHOD OF CONTROLLING ACCESS TO AUDIO AND VIDEO FEEDS IN A CLOSED NETWORK

(71) Applicant: PESA SWITCHING SYSTEMS, INC., WILMINGTON, DE (US)

(72) Inventor: DAVID L. ELLGEN, Madison, AL (US)

(73) Assignee: PESA SWITCHING SYSTEMS, INC., WILMINGTON, DE (US)

(21) Appl. No.: 15/975,436

(22) Filed: May 9, 2018

(51) Int. Cl. H04N 21/235; H04N 21/4363; G06F 21/50

(52) U.S. Cl. CPC H04N 21/2351; H04H 60/23; G06F 21/50; H04N 21/43635

(57) ABSTRACT

The system and method disclosed herein comprise a transmitter circuit and a receiver circuit that are programmed by a system administrator. The transmitter circuit receives audio and visual non-SMPTE formatted data signal via Serial Data Interface that it encodes to prevent unauthorized access. The scrambled and encoded data signal is transmitted to users within a closed network. The receiver circuit decodes the data signal allowing authorized access the data signal.

### CROSS-REFERENCE TO RELATED APPLICATIONS

This application does not claim priority to any patent application.

### DISCLOSURE REGARDING PRIOR DISCLOSURES BY THE INVENTOR OR A JOINT INVENTOR

The inventor has not disclosed this invention prior to the filing of this non provisional application.

### BACKGROUND OF THE INVENTION

### (1) Field of the Invention

This device is a system and method for processing both audio and video signals so that access to the signals can be controlled by an administrator. This system and method may be utilized in a closed network wherein users having access to the audio and/or video signals are connected to, or interface with, the administrator via a fiber optic network. Audio and video signals received by the administrator are coded with an encryption level. Only those users having proper authorization to decode or view the audio and/or video signal coded will be able to access the audio and/or video content. Thus, controlling access within the fiber optic network so that only users with the proper credentials are able to access encrypted content.

### (2) Disclosure of the Prior Art

There is a need to protect the access to video and audio data. Military and other government facilities often receive and transmit highly sensitive video and audio data that needs to be routed so that only certain authorized users have access to the data. For example, Bagram Air Base, which is located in Afghanistan, has a number of buildings and facilities contained within it's perimeter. Bagram Air Base receives video and audio data relating to enemy and friendly activities. There is a need for a system and method of routing video and audio data within Bagram Air Base so that only particular users are allowed access to specific video and audio data. A number of signal processing method and distribution systems routing audio and/or video data are known in the art. Current methods allow for limited audio and video formatting and polynomial encoding wherein the formatted and encoded audio and video is routed to users within the distribution system. But, these methods do not control who may access the audio and video data. Thus, unauthorized users may have access to audio and/or video that they should not be accessing. The system and method disclosed herein controls access to audio and video data so that a user may only access data that they have been authorized to access.

### BRIEF SUMMARY OF THE INVENTION

This system and method receives video and audio feed, and processes both feeds at the same time using a transmitter circuit. The transmitter circuit encrypts both video and audio feeds producing a secure SDI video. The secure SDI video may be encrypted so that video and audio feeds include multiple security level tags. For example, incoming video and audio feeds may be tagged unsecure and accessible to all users, or tagged security level 1, 2, or 3, etc. The secure SDI video is then transmitted via cable to a receiver circuit. Each user that is allowed access to the SDI video utilizes a receiver circuit to decode the secure SDI video. A user with credentials to access level 1 secure SDI video only is able to access level 1 video and audio data via a monitoring device connected to the receiver circuit. But a user with credentials to access only level 1 secure SDI video is unable to access level 2 video and audio data via the receiver circuit.

### BRIEF DESCRIPTION OF THE DRAWINGS

The invention is described in detail below with reference to the appended drawings. FIGS. 1 through 10 depict the System and Method of Controlling Access to Audio and Video Feeds in a Closed network. In the Figures:

FIG. 1 depicts a block diagram of the system and method herein.

FIG. 2 depicts an exemplary transmitter circuit utilized in the prior art, while FIG. 3 shows an exemplary receiver circuit utilized in the prior art.

FIG. 4 illustrates the transmitter circuit for the system and method and device herein.

FIGS. 5 and 6 illustrate the receiver circuit for the system and method device herein.

FIG. 7 depicts an exemplary transmitter box that encrypts video data and audio data.

FIG. 8 depicts an exemplary receiver box that decodes video data and audio data encrypted in FIG. 7.

FIG. 9 illustrates exemplary transmitter circuits that encrypt video and audio data with various encryption levels and transmit said encrypted data to a router.

FIG. 10 illustrates exemplary receiver circuits that receive encrypted data from a router and decode said data so that it can be accessed by a user.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an embodiment in the present disclosure, can be, but not necessarily, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same term can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

The system and method comprises a system administrator 4, a transmitter circuit 6, and a receiver 10 circuit.

The system administrator 4 may be a person or a computer program that programs and maintains programming of the transmitter and receiver circuits, 6 and 10, respectively.

Transmitter circuit 6 receives both non-secure video/audio data that is due to be encrypted and HDCP (High-Bandwidth Digital Content Protection) encrypted video and audio data. Transmitter circuit 6 includes transmitter box 59 that scrambles both the non-secure and HDCP data and encodes the data with a security flag. The security flag encodes the data with one or more security levels. Each transmitter box 59 can provide up to four individual outputs of the encoded video/audio signal. The encoded data may be transferred via one or more individual outputs to one or more receiver box(es) 61 over a SMPTE (“Society of Motion Picture and Television Engineers”) compliant video transport link. Alternately, the encoded data may be transferred via one or more individual outputs to router 200 for distribution within video infrastructure 100.

The encoded video and/or audio signal transmitted via transmitter circuit 6 is not viewable by any video or audio monitoring devices other than a properly configured receiver. This allows multiple signals to be transported within video infrastructure 100 while limiting access to the encoded video and/or audio signal to a particular receiver and a particular user of the receiver. This method prevents access by unauthorized users and can be employed to limit access to only specific workstations, users or user groups.

Receiver circuit 10 receives encoded data from transmitter circuit 6 and processes the data and allows authorized users to access the data in a SMPTE complaint and viewable HDMI (“High-Definition Multimedia Interface”) format.

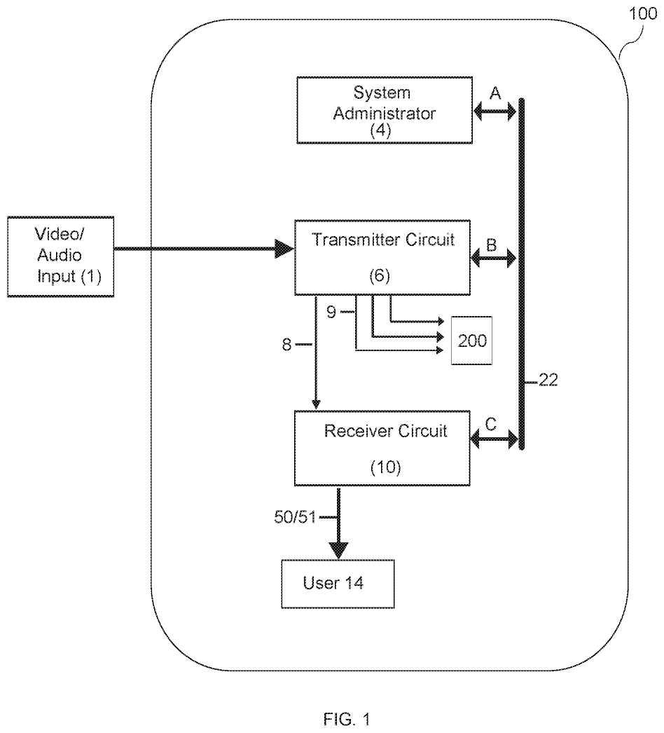

FIG. 1 depicts an overview of the system and method. Video infrastructure 100 includes the system within which the video/audio signal is distributed. Video infrastructure 100 may be a single building, two or more buildings in close proximity to each other, or an entire military base, such as Bagram Air Base. Video infrastructure 100 is a closed system, meaning that video/audio signals are transmitted within the system using a network of optic fibers, coaxial cables, or other suitable transmission lines. Thus, video infrastructure 100 does not utilize wireless transmission to transmit encoded video/audio data between transmitter circuit(s) 6 and receiver circuit(s) 10. Video infrastructure 100 utilizes ethernet 22 to allow system administrator 4 to program and re-program both the transmitter and receiver circuits as needed.

Video infrastructure 100 depicts transmitter circuit 6, receiver circuit 10, ethernet 22, router 200, and user 14. Video/audio input signal 1 may enter video infrastructure 100 as either HDCP encrypted or non-encrypted. Video/audio input signal 1 is received by transmitter circuit 6. Transmitter circuit 6 processes both HDCP and non-encrypted video, and audio data received and transmits the data to either router 200 via lines 9 or to receiver circuit 10 via line 8. User 14 accesses video and/or audio data through receiver circuit 10. Data accessed by user 14 is that data that is encoded at a security level that receiver 10 is authorized to decode and descramble. System administrator 4 is able to control the security level of each transmitter circuit 4 and receiver circuit 10 via ethernet 22.

System administrator 4 may be a computer programmed to program and re-program both transmitter circuit 6 and receiver circuit 10. System administrator 4 may not be able to view video/audio input signal 1 before or after data processing. This prevents breach of encryption protection by the system administrator 4.

System administrator 4 may preprogram transmitter circuit 6 to receive audio and/or video data, encode a specific security level onto the incoming video/audio input 1, and to transmit the encoded, scrambled data to receiver 10 and/or router 200. System administrator 4 via ethernet 22 may preprogram receiver circuit 10 to process data by decoding and descrambling the data corresponding to the preprogrammed security level set at receiver 10, and transmitting the data via audio out 50 and HDMI video out 51 via HDMI, SMPTE-complaint transmission to user 14 so that user 14 may view the decoded and descrambled video and audio data via a television, monitor, projector, or other display.

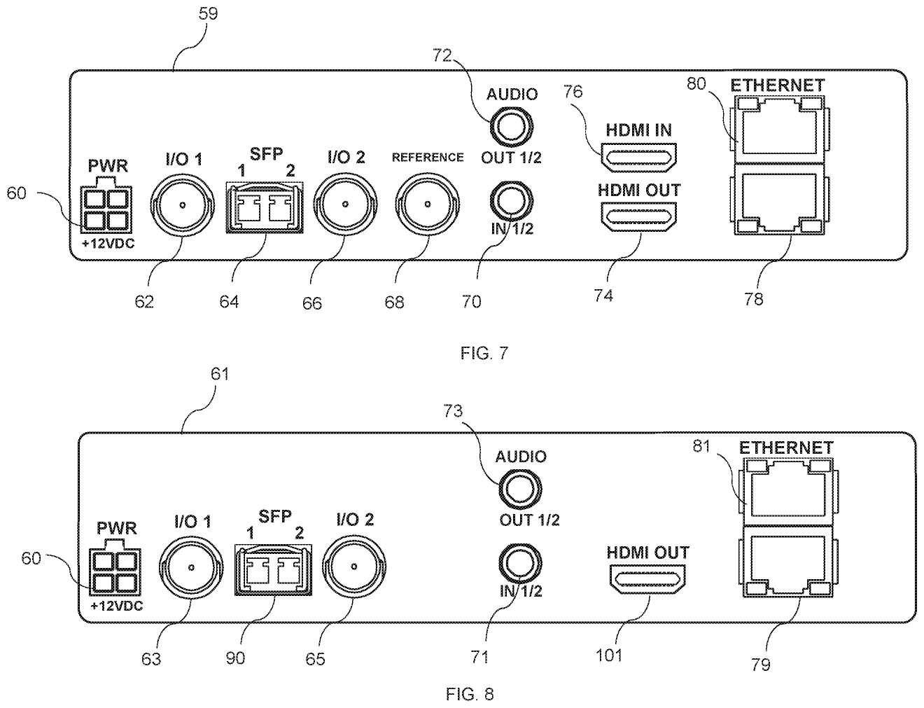

System administrator 4 may change the security level preprogrammed into transmitter circuit 6 and receiver circuit 10 via ethernet 22. System administrator 4 may send programming instructions via ethernet 22 at ethernet cable A to both transmitter circuit 6 and receiver circuit 10. Transmitter circuit 6 receives programming instructions from system administrator 4 via ethernet 22 at ethernet cable B. Receiver circuit 10 receives programming instructions from system administrator 4 via ethernet 22 at ethernet cable C. This allows both transmitter box 59 (shown in FIG. 7) and receiver box 61 (shown in FIG. 8) to remain in their physical location while changing the security level applied to data by transmitter circuit 6 and the security level of data that a user may view using receiver circuit 10. For example, a particular workstation in a flex area or conference room may be utilized by one or more individuals with different security authorizations. Receiver box 61 for the workstation may be preprogrammed to decode and descramble data only at base level. HDCP is base level in the exemplary embodiment. In the exemplary embodiment, all receiver circuits 10 are always programmed to process data at base level. If the workstation is to be utilized by an individual or group of individuals authorized to access video and audio data at level 2, for example, then system administrator 4 may change the security level of receiver circuit 10 to process data at level 2. When level 2 data is no longer needed at the workstation, system administrator 4 may change receiver box 61 so that it processes data only at base level.

Video/Audio input 1 is video and audio feed that enters video infrastructure 100. Video/Audio 1 includes both HDCP-encrypted video and non-encrypted video that feeds into transmitter circuit 6. Although the video infrastructure 100 depicted in FIG. 1 includes a single transmitter circuit 6, an exemplary system may include numerous transmitter circuits 6. For example, a video infrastructure 100 may include a single transmitter circuit 6 for each user or, alternatively, each workstation within video infrastructure 100 may have two or more transmitter circuits 6. HDCP data entering transmitter circuit 6 retains its SMPTE formatting. All non-HDCP (which is unencrypted “non-secure” data) data entering a particular transmitter circuit 6 is encrypted so that all data leaving transmitter circuit 6 is encrypted by transmitter circuit 6 at the security level programmed for transmitter circuit 6. If a workstation has just one transmitter circuit 6, then all incoming data will be encrypted at the preset security level. If a workstation has two or more transmitter circuits 6, then one video/audio input 1 could be processed at a transmitter circuit programmed at security level 1 while a second transmitter circuit 6 could have a different video/audio input 1 source wherein all data processed at the second transmitter circuit 6 is processed at security level 4.

At transmitter circuit 6 all data received from video/audio input signal 1, is encrypted with the programmed security level for the particular transmitter circuit 6. Encrypted video/audio signal 8 is transmitted from transmitter circuit 6 to receiver circuit 10. In FIG. 1, user 14 is authorized to receive encrypted video/audio signal 8 at the programmed security level set for receiver circuit 10. Receiver circuit 10 decodes encrypted video/audio signal 8 and transmits SMPTE compliant video out 51 and audio out 50 to user 14. User 14 then accesses video out 51 and audio out 50 via a computer monitor, projector and sound bar, television, etc.

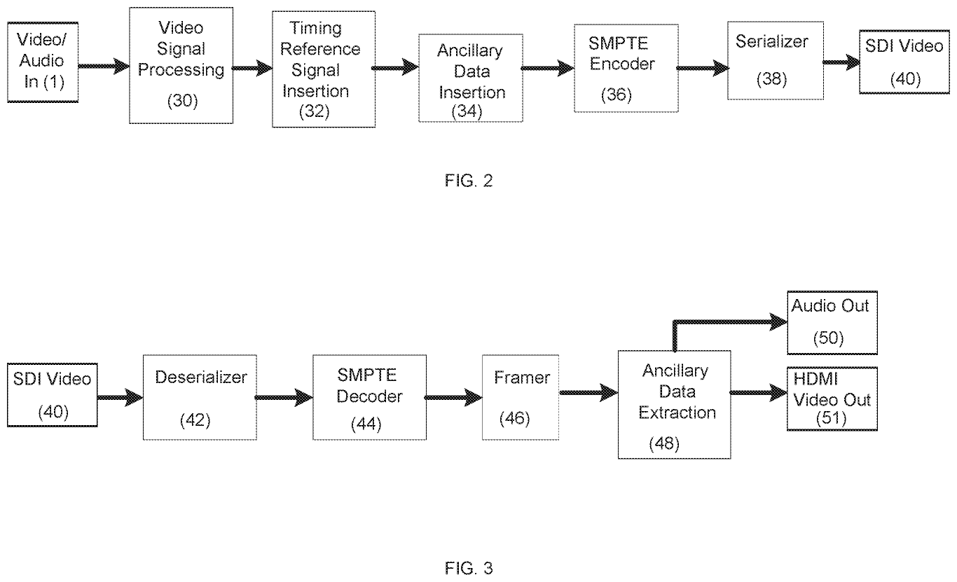

FIG. 2 depicts a sample transmitter circuit that reflects the current state of the art. In FIG. 2 video/audio data enters transmitter circuit via video/audio input 1. Video/audio input 1 entering the transmitter circuit is processed at video signal processing 30 so that the incoming signal may be converted, formatted, or otherwise optimized. Video signal processing 30 may transform video signal to be compatible with a SMPTE formatter. Following processing, the signal is subjected to standard formatting by timing reference signal insertion 32 and ancillary data insertion 34. The processed signal is modified by timing reference signal insertion 32. Timing reference signal insertion 32 syncs video and audio signals to ensure correct sync references between devices. Next, ancillary data insertion 34 inserts non-video information, such as audio, that may be embedded within the SDI. Ancillary data insertion is standardized by SMPTE.

Following standard formatting, a polynomial is encoded onto the formatted signal at step 36. Standard SMPTE encoder 36 encodes the video signal according to the SDI standard ensuring that the serial bitstream has sufficient level transitions to allow the receiving circuit (shown in FIG. 3) to recover the clock and data applied during standard formatting. Serializer 38 transmits signal data one bit at a time, sequentially, in the form of SDI video/audio signal 40 over a data cable.

FIG. 3 depicts a sample receiver circuit that represents the state of the art. FIG. 3 depicts the flow of SDI video signal 40 through the receiver circuit. SDI video/audio signal 40 is processed by deserializer 42. Deserializer 42 extracts the data from SDI video/audio signal 40 and presents the encoded video data on two 10-bit encoded data busses. Next, the video/audio signal is decoded by standard SMPTE decoder 44. The polynomial encoded at the transmitter circuit standard SMPTE encoder 36 (shown in FIG. 2) is decoded by standard SMPTE decoder 44. Next, framer 46 aligns the deserialized and decoded signal so that it can be properly word aligned. Lastly, ancillary data extraction 48 extracts data packets, such as audio embedded at ancillary data insertion 34, which may be located anywhere within the serial digital data stream coming from framer 46. Following ancillary data extraction 48, audio out 50 and HDMI video out 51 are accessible to a user. Audio out 50 may be heard on any compatible speaker, smart phone, electronic notebook. HDMI video out 51 allows a user to access the video on any HDMI compatible monitor, television, projector, or other display.

Current methods of video and audio signal transmission do not allow user access to the serial digital data stream to be monitored or controlled. Anyone with access to the receiver (containing the receiver circuit) may access the serial data stream. The invention herein scrambles the SDI data stream so that access to said data stream may be controlled.

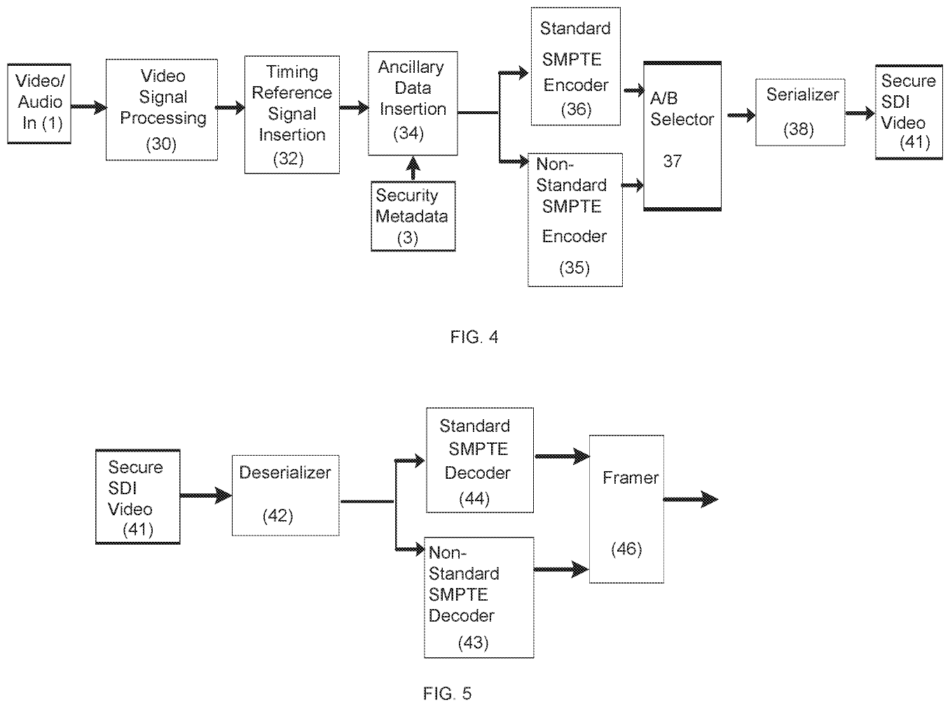

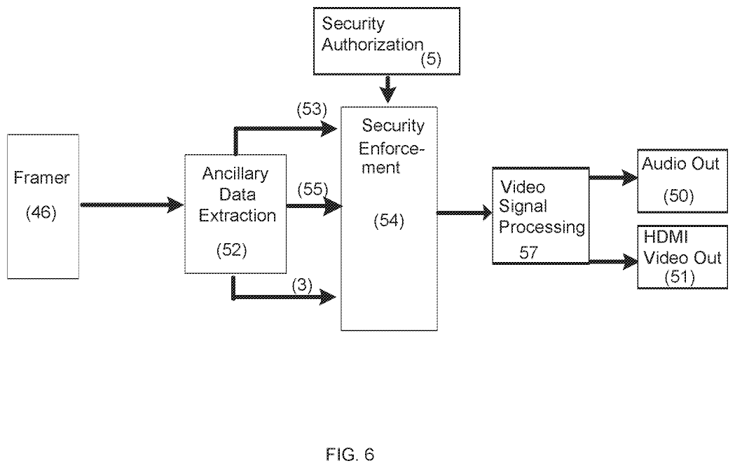

FIG. 4 depicts the transmitter circuit for the system and method of controlling access to audio and video feeds in a closed network, while FIGS. 5 and 6 depict the receiver circuit.

FIG. 4 depicts the transmitter circuit 6 processing of video/audio in 1 entering video infrastructure 100 at video signal processing 30 through the transmission of secure SDI video 41 feed that is sent to receiver circuit 10. At video signal processing 30 the incoming signal is processed so that the feed is SMPTE compatible. At timing reference signal insertion 32 the timing reference signal is inserted into the SMPTE-compatible signal so that the video and audio signals are synced with correct alignment. Following insertion of a timing reference, ancillary data insertion 34 inserts into the signal non-video data, such as audio or other format options. Security metadata 3 is inserted into the signal during ancillary data insertion 34.

Security metadata 3 insertion may include both inserting a scramble level and inserting a security level flag into the data stream being processed. For example, a transmitter circuit programmed to encode data at a base level will insert security metadata 3 at the base level. Alternatively, a transmitter circuit may be programmed to encode data at both base and level 1. An exemplary embodiment comprises programming transmitter circuit 6 so base level, and levels 1 through 7 are programmable. This embodiment may be programmed so that base encryption level is that level of security applied to HDCP per SMPTE guidelines. Levels 1 through 7 may represent encryption levels above base so that the least secure level is 1 and the level of security increases at each level so that the maximum security level is level 7. The embodiment may include all users of the system having access to base level and access to levels 1 through 7 based on criteria established by system administrator 4 (shown in FIG. 1). Security criteria may be different for each video infrastructure 100 (shown in FIG. 1) wherein the system and method is utilized. The addition of security metadata 3 to transmitter circuit 6 allows an encoder(s) to recognize the security level of incoming data signals.

Data transmitted from ancillary data insertion 34 is processed by either standard SMPTE encoder 36 or non-standard SMPTE encoder 35. Data within the data stream transmitted from ancillary data insertion 34 is encoded with a polynomial pursuant to standard SMPTE formatting at standard SMPTE encoder 36. Standard SMPTE encoder 36 formats the data signal at the base level. Standard SMPTE encoder 36 uses an algorithm to scramble the data signal. The algorithm utilized is the algorithm standard to SMPTE formatting. Standard SMPTE encoder 36 encodes the data signal according to the SDI standard ensuring that the serial bitstream has sufficient level transitions to allow the receiving circuit to recover the clock and data applied during standard formatting at timing reference signal insertion 32 and ancillary data insertion 34. Standard SMPTE encoder 36 encodes all data received to be SMPTE compliant.

Non-standard SMPTE encoder 35 may encrypt both video and audio data with an algorithm. Encryption at non-standard SMPTE encoder 35 scrambles the signal so that only a properly programmed receiver circuit can access the video/audio data signal. Non-standard SMPTE encoder 35 may scramble the incoming data signal so that the data signal is encrypted with multiple levels of security. For example, non-standard SMPTE encoder 35 may be programmed to scramble data at level 1, or level 2, etc. A total of 255 security levels may be assigned to the data signal at non-standard SMPTE encoder 35.

Data is transmitted to non-standard SMPTE encoder 35 to be encoded with a polynomial that is different from the polynomial utilized to encode standard SMPTE formatting. Non-standard SMPTE encoder 35 is programmed by system administrator 4 (shown in FIG. 1) to scramble data pursuant to a polynomial that differs from the standard SMPTE polynomial. Non-standard SMPTE encoder 35 encodes all data signal received by it at the programmed security level assigned to the transmitter circuit 6. Non-standard SMPTE encoder 35 encodes the data signal flagged with security megadata 3 security level ensuring that the serial bitstream has sufficient level transitions to allow a receiving circuit programmed at the correct security level to recover the clock and data applied during formatting at timing reference signal insertion 32 and ancillary data insertion 34.

Both standard SMPTE encoder 36 and non-standard SMPTE encoder 35 may utilize pixel-based scrambling wherein scrambling is performed by changing the position of the pixels in an image based on a preprogrammed polynomial algorithm. Standard SMPTE encoder 36 utilizes the standard SMPTE polynomial algorithm to scramble data, while the non-Standard SMPTE encoder 35 utilizes a polynomial algorithm different from the polynomial algorithm utilized by standard SMPTE encoder 36. For example, non-standard SMPTE encoder 36 may use a polynomial algorithm such as G₁(X)=X₉+X₄+1 to scramble data.

In one exemplary embodiment, non-standard SMPTE encoder 35 may encrypt data at base level or one of seven different levels of security. Base level would be HDCP compliant formatting. Levels 1 through 7 with level 1 being the least secure and level 7 being the most secure. Certain individuals, or a group of individuals, may have the need to access video/audio with a security level 1, while other individuals are authorized to access video/audio with both security levels 1 and 2. In this exemplary embodiment, only a single individual may be authorized to view video/audio with a security level 7.

Data scrambled at both non-standard SMPTE encoder 35, and at standard SMPTE encoder 36 is transmitted to A/B selector 37. A/B selector 37 always picks up scrambled data from non-standard SMPTE encoder 35 and standard SMPTE encoder 36. But, A/B selector 37 decides, based on its programming, whether to give serializer 38 scrambled data from non-standard SMPTE encoder 35 or scrambled data from standard SMPTE encoder 36. System administrator 4 (shown in FIG. 1) may program A/B selector 37 to allow encoded signals to be sent from standard SMPTE encoder 36 to serializer 38. All data signal sent from standard SMPTE encoder 36 is base level HDCP signal.

Alternatively, system administrator 4 may program A/B selector 37 to allow encoded signals to be sent from non-standard SMPTE encoder 35 to serializer 38. All data signal sent from non-standard SMPTE encoder 35 to serializer 38 has an encrypted security level, which may be a level from 1 to 7 in the exemplary embodiment. Thus, A/B selector 37 allows video/audio signals of multiple security levels, including HDCP and any preset level, to flow through the transmitter circuit to serializer 38 subject to system administrator 4 programming.

Serializer 38 transmits signal data one bit at a time, sequentially, as secure SDI video 41. The secure SDI video 41 feed is fully secure and protected so that an unauthorized user may not view the data signal. Only a user with a receiver containing the reverse of the polynomial encoded by either standard SMPTE encoder 36 or non-standard SMPTE encoder 35 may access the data signal. Secure SDI video 41 includes both video and audio data signals. Secure SDI video 41 is preferably transmitted over fiber optic cable, allowing system administrator 4 (shown in FIG. 1) to control transmission of the video and audio data within a large building, among several buildings located proximate to each other, or within a military base, such as Bagram Air Base. The addition of both security metadata 3 and encoding, either standard SMPTE or non-standard SMPTE, provides increased protection of the data signal reducing the likelihood that non-authorized users will be able to access the data signal.

The receiver circuit is depicted in FIGS. 5 and 6. FIG. 5 depicts the processing of secure SDI video 41 from deserializer 42 through framer 46 and FIG. 6 depicts processing from framer 46 through audio out 50 and HDMI video out 51.

Secure SDI video 41 is processed by deserializer 42 wherein deserializer 42 extracts data from secure SDI video 41 and converts the extracted data between serial data and parallel interfaces in order to provide data transmission to standard SMPTE decoder 44 and to non-standard SMPTE decoder 43 over a single/differential line.

Data transmitted from deserializer 42 to standard SMPTE decoder 44 is descrambled according to the polynomial encoded at standard SMPTE encoder 36 (shown in FIG. 4). Data is also transmitted from deserializer 42 to non-standard SMPTE decoder 43 where it is descrambled according to the polynomial encoded at non-standard SMPTE encoder 35. Descrambled data from standard SMPTE decoder 44 and non-standard SMPTE decoder 43 is transmitted to framer 46. Only one of the decoders will have a valid output which can be read by framer 46, as determined by the security metadata 3 previously inserted into the SDI signal at transmitter circuit 6.

The reverse of the standard SMPTE-encoded algorithm encoded by standard SMPTE encoder 36 is provided in receiver circuit 10 to enable viewing of the standard SMPTE formatted data signal. All receiver circuits 10 may be programmed to access standard SMPTE-encoded signal.

The reverse of the non-standard SMPTE encoded algorithm is provided in each receiver circuit 10 to enable viewing of the non-standard SMPTE video/audio signal. In the preceding example, if non-standard SMPTE encoder 35 scrambles the data signal with the following polynomial algorithm: G₁(X)=X₉+X₄+1, then non-standard SMPTE decoder 43 would use the following reverse polynomial algorithm: G₁(X)/X₉+X₄+1=, to decode and descramble the scrambled data signal.

FIG. 6 depicts the receiver circuit from framer 46 through final processing that produces a fully HDMI complaint signal. The decoded and descrambled video/audio data signal is transmitted from framer 46 to ancillary data extraction 52. Ancillary data extraction 52 extracts metadata 3 (shown in FIG. 4), audio packet 53, secure video 55, or other security metadata that may have been embedded at transmitter circuit 6. The data extracted at ancillary data extraction 52 is transmitted to security enforcement 54. Security enforcement 54 is controlled by system administrator 4 (shown in FIG. 1) via security authorization 5. Security enforcement 54 transmits to video signal processing 57 only that data authorized by security authorization 5. System administrator 4 programs security authorization 5 setting the security level that is allowed to be transmitted to video signal processing 57. For example, system administrator 4 may program security authorization 5 to only permit data at base level to be transmitted to video signal processing. Instead, system administrator 4 may program security authorization to allow security enforcement to permit all levels, including base and levels 1 through 7, to be transmitted to video signal processing 57. Security enforcement 54 allows system administrator 4 to control which user(s) has access to specific video/audio data. For example, system administrator 4 is able to deny access to a user requesting access to data rated with security level 2 if the user only has authorization to access level 1 video/audio data. Security enforcement 54 matches the security authorization 5 transmitted to it to the security level of the user to confirm that the user is authorized to access signal data of the level requested. If a user requests to access data with a security level 5 but that user only has authorization to access level 4 signal data, then the user may view a blank display on his or her monitor.

Video signal processing 57 processes the data signal received from security enforcement 54 so that the data signal/feed it transmits to a user is HDMI SMPTE compliant. Audio out 50 and HDMI video out 51 are fully accessible to a user.

FIG. 7 shows an exemplary transmitter box 59, that contains transmitter circuit 6 (shown in FIG. 4). FIG. 7 illustrates the necessary components. Additional components may be added to transmitter box 59 per user needs. System administrator 4 programs transmitter box 59 to serve as transmitter circuit 6. System administrator 4 programs transmitter box 59 to encode and encrypt incoming video and audio data at either base level or other security level. Transmitter box 59 may receive both HDCP encrypted data and non-encrypted data. Power receptacle port 60 allows transmitter box 59 to be connected to a power source. Input/output (I/O) port 62 and 66 are used in this embodiment to transmit secure SDI video 41 from transmitter box 59 via coaxial cable to receiver circuit 10. SFP (small form-factor pluggable) module 64 allows a user to connect two fiber optic cables to transmitter box 59 to transmit secure SDI video 41 from transmitter box 59 to receiver circuit 10.

Reference port 68 may be used to sync video input and/or video output sources together to ensure the coincidence of signals in time at a combining or switching point. Audio IN 1/2 70 allows analog audio from an auxiliary source into transmitter box 59 for processing. For example, if audio data embedded onto the HDMI Signal entering transmitter box 59 at HDMI IN 76 is in the Arabic language, a user may use Audio IN 1/2 70 to add a source of English language audio. Embedded audio feed entering the transmitter box 59 at HDMI IN 76 may be replaced in the SDI output signal (output I/O 1 62, output I/O 2 66, and SFP module 64) with auxiliary audio from Audio IN 1/2 70 by transmitter circuit 6. Audio OUT 1/2 72 provides an analog output of the actual audio signal embedded in the SDI output signal (output I/O 1 62, output I/O 2 66, and SFP module 64).

HDMI IN 76 allows video and embedded audio data to enter transmitter box 59 for processing via transmitter circuit 6. HDMI OUT 74 may be utilized to connect a monitor or display to view non-encrypted HDMI video not being processed by transmitter circuit 6. Ethernet port 80 allows an ethernet cable to connect transmitter box 59 to ethernet 22 via ethernet cable B. System administrator 4 sends programming commands to transmitter box 59 to set security levels for data processing via ethernet 22 that is ported into transmitter box 59 via ethernet port 80. Ethernet port 78 allows the user to chain the ethernet connection from transmitter box 59 to another transmitter box 59 or a receiver box 61 (shown in FIG. 8).

FIG. 8 depicts receiver box 61. Receiver box 61 contains the components of receiver circuit 10. Additional components may be added to receiver box 61 per user needs. Power receptacle port 60 allows receiver box 61 to be connected to a power source. Receiver box 61 may receive secure SDI video 41 at input I/O 1/2 63, input I/O 1/2 65, and SFP module 90. Multiple input ports allow a single receiver box 61 to access video/audio feeds from multiple sources, or multiple transmitter boxes 59. Audio IN 1/2 71 allows analog audio from an auxiliary source into receiver box 61 for processing. For example, if audio data embedded onto the SDI input signal entering receiver box 61 at input I/O 63, input I/O 2 65, or SFP module 90 is in the English language, a user may use Audio IN 1/2 71 to add a source of Arabic language audio. Embedded audio feed entering receiver box 61 at input I/O 1 63, input I/O 2 65, and SFP module 90 may be replaced in the HDMI output signal 101 with auxiliary audio from Audio IN 1/2 71 by receiver circuit 10. Audio OUT 1/2 73 provides an analog output of the actual audio signal embedded in the HDMI output signal 101. HDMI out 101 transmits HDMI video out 51 to a monitor, television, projector, or other display. Ethernet port 81 allows an ethernet cable to connect receiver box 10 to ethernet 22 permitting system administrator 4 to program receiver circuit 10 via ethernet cable C. Ethernet port 79 allows a user to chain the ethernet connection from receiver box 61 to another receiver box 61.

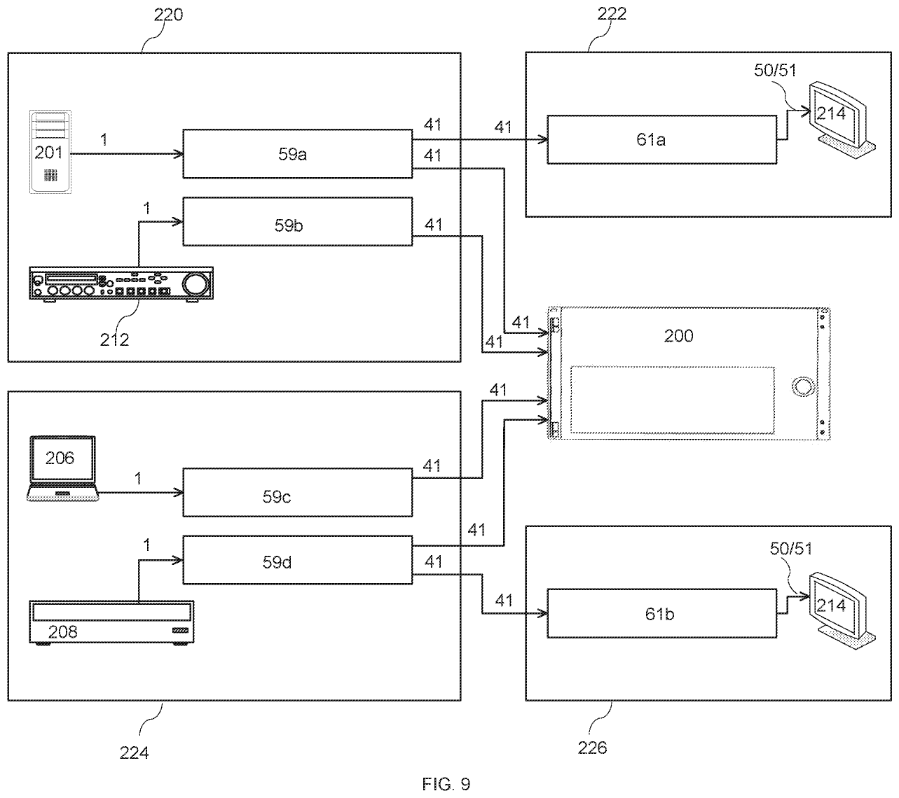

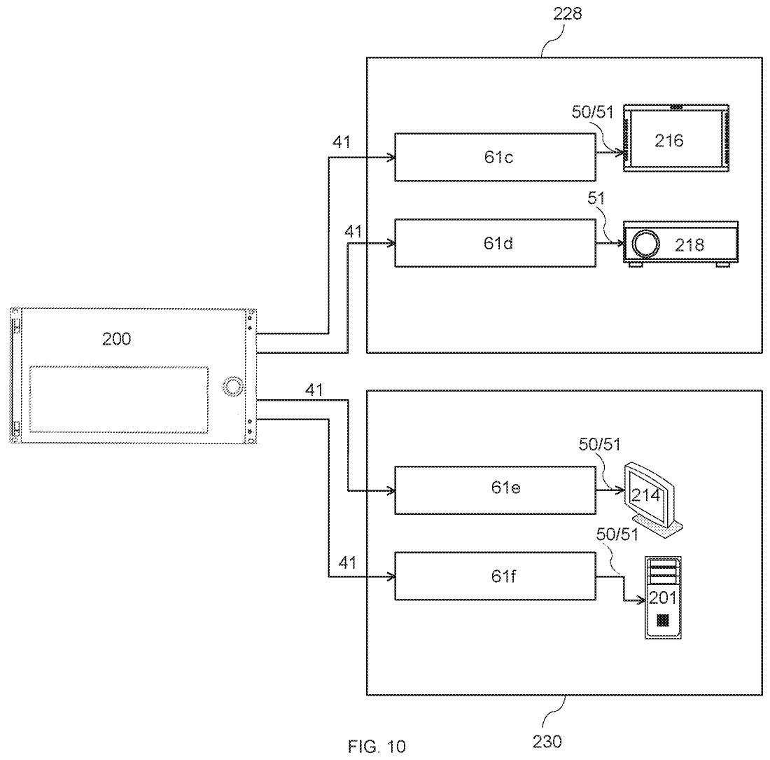

FIGS. 9 and 10 illustrate an exemplary configuration of the invention herein at a secure military facility, such as Bagram Air Base. FIG. 9 depicts the processing and transmission of video and audio data signal via transmitter circuit 6 (shown in FIG. 1) up to the point of SDI video router 200 transmission. FIG. 10 depicts the transmission of secure SDI video 41 through the military base via SDI video router 200 and to users that access the data signal. In command center module 222, HDMI video containing classified video data is transmitted from computer 201 via video/audio in 1 to transmitter box 59a. Transmitter box 59a may encrypt via scrambling and encoding secure SDI video 41 at level 6 security. HDMI video containing sensitive data from modem 212 is transmitted to transmitter box 59b via video/audio in 1. Transmitter box 59b may process video/audio 1 converting it into secure SDI video 41 at level 5 security. Secure video 41 from transmitter boxes 59a and 59b is transmitted to SDI video router 200. SDI video router 200 transmits the encrypted and encoded secure SDI video 41 in its secure form without further processing. Local mission commander 222 module receiver secure SDI video 41 from transmitter box 59a. Receiver 61a is programmed to descramble and decode secure video 41 at security level 6. Receiver 61a converts secure SDI video 41 so that audio out 50 and video out 51 may be heard and viewed on monitor 214.

Data distribution module 224 transmits HDMI video/audio containing sensitive data to transmitter box 59c, which encrypts the data signal at level 2 before transmitting it to SDI video router 200. Video recorder/player 208 transmits HDMI video and audio with HDCP encryption via video/audio in 1 to transmitter 59d. Transmitter 59d processes video/audio 1 and transmits it as secure SDI video 41 at base level encoding. Secure SDI video 41 is transmitted from transmitter 59d to both SDI video router 200, allowing it to be transmitted to multiple receiver boxes 61 within video infrastructure 100, and to local video programming monitor post module 226. Local video programming monitor post 226 processes the data signal received from transmitter 59d with receiver 61b. Receiver 61b decodes secure SDI video 41 at base level security to display HDCP SMPTE compliant video and to broadcast SMPTE compliant audio. Audio out 50 and video out 51 are heard and viewed via monitor 214. In the present embodiment, all receiver boxes 61 in FIGS. 9 and 10 are set to decode and descramble base security level data.

SDI video router 200 transmission of secure SDI video 41 is shown in FIG. 10. SDI video router 200 is shown with four inputs and four SMPTE compliant secure SDI video 41 outputs. The data signal transmitted into and out of SDI video router 200 is not viewable without further processing by a properly programmed receiver 61. Operations control center module 228 includes receiver 61c, which is programmed to decrypt and decode all security levels within video infrastructure 100 (shown in FIG. 1) and transmits video out 51 so that it can be viewed by display 216. Receiver 61d processes and transmits secure SDI video 41 only at level 5 security encryption. Receiver 61d transmits video out 51 to projector 218 so that video out 51 may be viewed using projector 218.

Video distribution operations 230 receives secure SDI video 41 from SDI video router 200. Receiver 61e processes and converts secure SDI video 41 that is encrypted at security level 2. Receiver 61f is programmed to decrypt and decode secure SDI video 41 at base level only. Receiver 61f receives data signal from router 200 and decodes only data that is flagged at HDCP base level signal. HDCP data that has been decoded at receiver 61f is transmitted to computer 201 for user access.

I hereby claim:

The inventor hereby claims:

1. A system that controls user access to video data within a closed network comprising:
a transmitter circuit that receives video data that is due to be encrypted, wherein the transmitter encrypts the video data with a security flag that encodes at least one security level; wherein the video data is scrambled by changing the position of the video image using a scrambling polynomial algorithm, wherein the scrambling polynomial algorithm is not the polynomial algorithm utilized by the Society of Motion Picture and Television Engineers to encrypt video data; wherein the transmitter circuit transmits the scrambled video data to a receiver circuit;
a receiver circuit that receives the scrambled video data from the transmitter circuit; wherein the receiver circuit descrambles the scrambled video data using a descrambling polynomial algorithm; wherein the descrambling polynomial algorithm is the reverse of the scrambling polynomial algorithm; wherein the receiver circuit transmits to a user descrambled video data viewable in High-Definition Multimedia Interface format; wherein the descrambled video data is compliant with the Society of Motion Picture and Television Engineer standards;
a system administrator that programs the transmitter circuit and the receiver circuit; and
only a user authorized by the system administrator may receive the descrambled video data transmitted from the receiver circuit.

2. The invention of claim 1, wherein audio is embedded in the video data.

3. The invention of claim 1, wherein audio is embedded in the descrambled video data.

4. The invention of claim 1, wherein the transmitter circuit transmits video data to a router, and the receiver circuit transmit receives video data from the router.

5. The invention of claim 1, wherein the scrambled video data is not viewable to a user unless authorized by the system administrator.

6. The invention of claim 1, wherein the transmitter circuit further comprises:
a standard Society of Motion Picture and Television Engineers encoder that encodes video data,
a non-standard Society of Motion Picture and Television Engineers encoder that encodes video data, and
a selector that receives video data from both the standard Society of Motion Picture and Television Engineers encoder and the non-standard Society of Motion Picture and Television Engineers encoder, wherein the selector selects whether to transmit to a serializer scrambled video data from the standard Society of Motion Picture and Television Engineers encoder or scrambled video data from the non-standard Society of Motion Picture and Television Engineers encoder; and
a serializer that transmits scrambled video data from the selector to the receiver circuit.

7. The invention of claim 1, wherein the receiver circuit further comprises:
a standard Society of Motion Picture and Television Engineers decoder that descrambles scrambled video data transmitted from the transmitter circuit,
a non-standard Society of Motion Picture and Television Engineers decoder that descrambles scrambled video data transmitted from the transmitter circuit, and
a security enforcement means that allows descrambled video data to be viewable by users authorized by the system administrator.

8. The invention of claim 1, wherein security metadata inserts a scramble level into video data being transmitted within the transmitter circuit.

9. The invention of claim 1, wherein security metadata inserts a security level flag into the video data being encrypted by the transmitter circuit.

10. The invention of claim 1, wherein video data is encrypted at a base security level, wherein the base security level is compliant with Society of Motion Picture and Television Engineers standards.

11. The invention of claim 1, wherein video data is encrypted at a security level of 1 through 7, wherein 1 is a lowest security level of encryption and 7 is a highest level of encryption.

12. The invention of claim 1, wherein the transmitter circuit is preprogrammed to encrypt video data at a preset level.

13. The invention of claim 1, wherein the receiver circuit is preprogrammed to descramble scrambled video data at a preset level.

14. The invention of claim 1, wherein the system administrator may add or remove user authorization to view the descrambled video data.

15. The invention of claim 7, wherein the system administrator programs the security enforcement means to authorize users to view the descrambled video data.

16. A method of controlling user access to video data within a closed network comprising:
a transmitter circuit that receives video data to be encrypted,
processing of the video data by the transmitter circuit so that the video data transmitted from the transmitter circuit is encrypted with non-standard Society of Motion Picture and Television Engineers encoding,
distribution of encrypted video data from the transmitter circuit to a receiver circuit within the closed network,
processing of encrypted video data by the receiver circuit so that the encrypted video data is viewable by an authorized user,
wherein an unauthorized user is unable to view the encrypted data transmitted by the transmitter circuit.

17. The method of claim 16 wherein the closed network is a military installation, government building, or two or more government buildings.

18. The method of claim 16 wherein a router located within the closed network receives encrypted data from the transmitter circuit and transmits the encrypted data to the receiver circuit.

19. The method of claim 16, further comprising a system administrator that programs the transmitter circuit with a level of encryption to process the video data.

20. The method of claim 16, further including a system administrator that programs the receiver circuit with a level of de-encryption to process encrypted video data.
